(19) United States
(12) Patent Application Publication
(10) Pub. No.: US 2008/0198487 A1
(43) Pub. Date: Aug. 21, 2008

(54) Single step method for transferring digital motion pictures to movie theater systems

(75) Inventors: Purushotham G. Lala Balaji, St. Paul, MN (US); Todd W. Abrahamson, Woodbury, MN (US); Stephen H. Dwyer, Woodbury, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/708,784

(22) Filed: Feb. 20, 2007

(51) Int. Cl. G11B 5/633; G08B 13/14; G11B 20/00

(52) U.S. Cl. 360/3; 340/572.1; 369/53.1

(57) ABSTRACT

The disclosure is directed to techniques for transferring data files representing a digital motion picture to a motion picture system within a theater in a single step. More specifically, the techniques allow a user to press one button to initiate the transfer, or upload, of a plurality of data files stored on a data tape to a predetermined location within a data storage device within the theater. The single input from the user frees the user from completing the plurality of steps needed to manually select a desired data file from the data tape and find the location to transfer the data file. Instead, the data tape or user system may automatically identify the entire plurality of data files and the predetermined location at which to store the plurality of data files. The techniques facilitate the distribution of motion pictures from motion picture studios to theaters using magnetic tape media.

### TECHNICAL FIELD

The disclosure relates to digital motion pictures and, more particularly, managing digital motion picture data files.

### BACKGROUND

Motion picture studios typically follow a number of steps to distribute a motion picture to movie theaters which present the motion picture to an audience. Distribution of the motion picture begins with an original completed copy of the motion picture shipped to a publication studio. The media containing the motion picture may be one or more reels of 8 millimeter film, 35 millimeter film, or other types of film. The publication studio then creates copies of the film and distributes the reels of film to the movie theaters that will show the motion picture. In some cases, the publication studio may outsource the creation of film copies.

Each movie theater may receive one copy of the motion picture for each projector that will be used to show the motion picture. A user, e.g., a movie theater employee or owner, then needs to unpack each film reel, place the correct film reel on the desired projector, and correctly place the film within the projector. In addition, some motion pictures may require the user to exchange film reels during the movie and prevent the audience from recognizing the change in film reels.

### SUMMARY

The disclosure is directed to method and system for restoring digital motion picture data files in a single step. More specifically, the method allows a user to press one button to initiate the transfer, or upload, of a plurality of data files stored on a data tape to a predetermined location within a data storage device. The single input from the user frees the user from completing the plurality of steps needed to manually select desired data files from the data tape and find the location to transfer the data files. The data tape or user system automatically identifies the entire plurality of data files and predetermined location to store the plurality of data files. The stored plurality of data files may then be used for the intended application without needing to again retrieve the plurality of data files from the data tape.

An example use of this method relates to the distribution of motion pictures from motion picture studios to theaters using magnetic tape media. Instead of using large film reels or expensive and fragile hard disk drives, a motion picture may be stored on data tape as the plurality of data files for shipment to movie theaters. The data tape is more resistant to damage from shipping or user handling once received. The user may insert the data tape into the tape system at the theater and provide a single input that initiates the automatic transfer of the plurality of data files to a predetermined location of a data storage device of the tape system. In this manner, the user may stream or otherwise transfer the plurality of data files to a specific projector that presents the motion picture to an audience.

In one example, the disclosure provides a method that includes receiving a single input from a user and transferring a plurality of data files from a data tape to a predetermined location within a data storage device of a movie theater in response to receiving the single user input, wherein the plurality of data files represent a motion picture.

In another example, the disclosure provides a system that includes a data tape that stores a plurality of data files, wherein the plurality of data files represent a motion picture. The system also includes a user interface that receives a single input from a user and a processor that transfers the plurality of data files from the data tape to a predetermined location within a data storage device of a movie theater in response to the single input.

In an additional example, the disclosure provides a computer-readable medium that includes instructions that cause a processor to receive a single input from a user and transfer a plurality of data files from a data tape to a predetermined location within a data storage device of a movie theater in response to receiving the single user input, wherein the plurality of data files represent a motion picture.

In another example, a system comprises a plurality of digital movie projectors within a movie theater, and at least one data server to store a plurality of different digital motion pictures. The data servers are coupled to the projectors via a network. The system further includes a data tape that stores an additional digital motion picture arranged as a plurality of different data files, and a tape drive coupled to the data server to receive the data tape. In response to insertion of the data tape within the tape drive user interface software on the data server presents a user interface to receive input from a user. The data server transfers the plurality of data files from the data tape to a predetermined location within the data server so that the additional digital motion picture is accessible by the digital movie projectors without requiring that the user provide more than a single input via the user interface.

The disclosure, in various examples, may be capable of providing a number of advantages. In general, the system and method described herein may reduce the knowledge needed of a user to successfully transfer data from a data tape to a data storage device by automatically performing the function initiated by a single input. The distribution of motion pictures via data tapes may reduce the cost associated with digital media and shipping to theaters while improving the reliability of the digital media that is shipped due to higher resistance to gravitational shocks of shipping provided by the data tapes. Data tapes offer greater sustainable data transfer rates and large storage capacities than other conventional digital media, which may reduce transfer times associated with the distribution process of motion pictures. Data tapes may also offer higher capacity sizes than traditional movie reels such that a data tape may hold multiple movies, or data sets, on a single tape.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram of an example process of distributing a motion picture via magnetic tape media.

FIG. 2 is a flow chart illustrating the technique of FIG. 1 regarding distribution of a motion picture via magnetic tape media.

FIG. 3 is a block diagram of an example system that accepts a data tape, transfers the plurality of data files from the data tape to a data storage device, and provides the plurality of data files to networked projectors.

FIG. 4 is a flow chart illustrating the technique of FIG. 3 regarding transfer and playback of the plurality of data files from a data tape.

FIG. 5 is a block diagram of an example system that acquires encryption keys for playback of the plurality of data files.

FIG. 6 is a flow chart illustrating the technique of FIG. 5 regarding acquiring encryption keys for the playback of the plurality of data files.

FIGS. 7A and 7B are example screen shots of writing the plurality of data files to the data tape and transferring the plurality of data files from the data tape, both with a single input from a user.

FIG. 8 is a flow chart illustrating the technique of FIG. 7A of writing a plurality of data files to a data tape with a single input from a user.

FIG. 9 is a flow chart illustrating the technique of FIG. 7B of transferring the plurality of data files from the data tape to a system with a single input from a user.

### DETAILED DESCRIPTION

The disclosure is directed to transferring a plurality of data files from a data tape to a data storage device with a single input from a user. The user may receive the data tape from a distributor that contains the plurality of data files. The data tape is configured to be inserted into a tape drive that is capable of reading the plurality of data files from the data tape. The tape drive is controlled by a processor of the tape system, and the processor directs a user interface to prompt the user to initiate the upload of the plurality of data files from the data tape. Once the user provides the single input to the user interface, the tape system uploads the plurality of data files to a predetermined location of a data storage device without any additional input from the user. The data tape, therefore, contains a layer of intelligence to complete the transfer process without requiring input from a user. In this manner, the user may avoid complex steps commonly associated with transferring data files from data tapes to data storage devices of other systems.

The transferring of a plurality of data files with a single input from a user is directed to the distribution of motion pictures from movie studios to movie theaters. Distributing motion pictures on a data tape (e.g., a digital motion picture on a digital magnetic tape) has not been aggressively pursued due to the conventionally complex method of transferring data from the data tape to a data storage device. The transfer method may require that the user identify desired blocks of data on the data tape and transfer the correct blocks of data to the correct location within the data storage device. Without knowledge of the tape system, transfer of the entire digital motion picture may require a trained user. However, the implementation of the process and system described herein automates the transfer process with the use of only a single input from a user to transfer the digital motion picture (e.g., the plurality of data files) from the data tape to the predetermined location of the data storage device. The movie theater system then makes accessible the digital motion picture to any networked projectors within the theater.

Data tapes may reduce the cost, increase security, and simplify conventional methods of distributing motion pictures. Distributing motion pictures via film reels requires expensive reels of film for each projector of a movie theater that are expensive to produce and ship. In addition, the movie studio has no control over the use of each film reel. Distributing motion pictures via hard disk drives require expensive hard disk drives susceptible to shipping damage, easy motion picture theft or duplication, and hard disk drive theft. Distributing motion pictures stored as a plurality of data files on a data tape may provide an inexpensive method to motion picture distribution that also reduces the possibility of damage to the motion picture media and theft due to the limited usage of data tapes as storage media within the consumer market. In addition, theft of data tapes with motion pictures may be limited due to the necessary tape drive and tape system required to transfer the motion picture from the data tape. Other advantages that motion picture distribution with data tapes may offer will be described below.

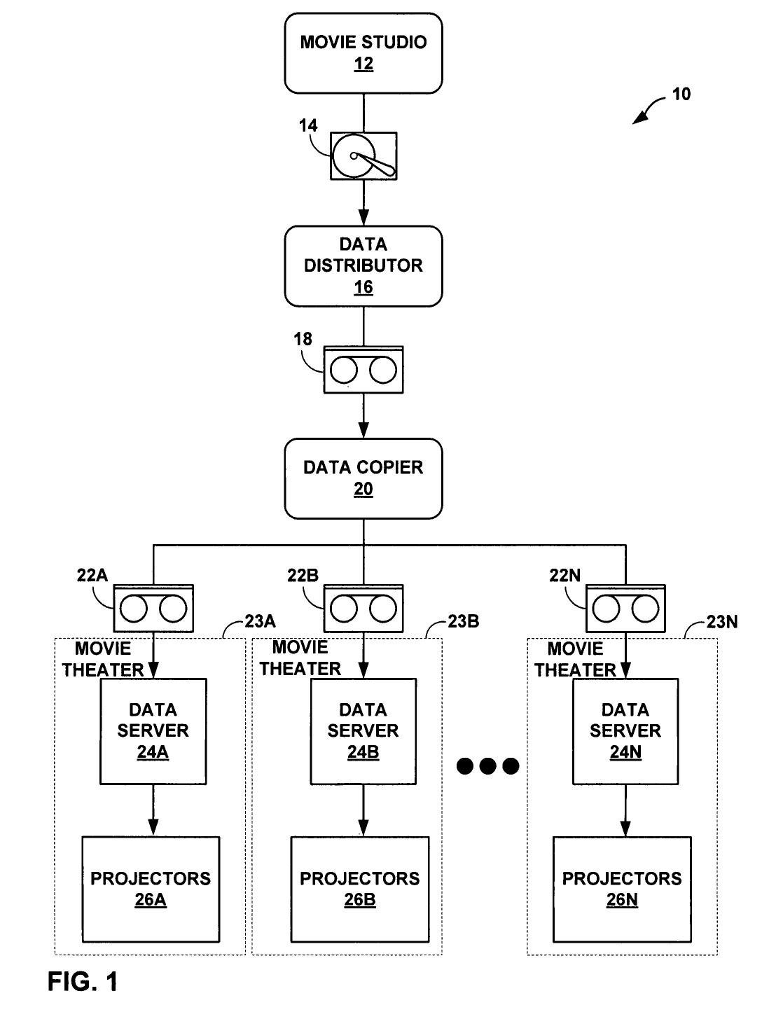

FIG. 1 is a block diagram of an example process of distributing a motion picture via magnetic tape media. As shown in FIG. 1, distribution system 10 includes movie studio 12, data distributor 16, and data copier 20 which create and distribute data tapes 22A, 22B and 22N (collectively “data tapes 22”) with a plurality of data files of a motion picture. Movie studio 12 initially creates hard disk 14 from the director's or the producer's final version of the motion picture. This step may include sampling the motion picture from film form into a digital representation of the film or copying motion picture data created by digital camera and audio sources. In some examples, hard disk 14 may take the form of a tape media, reels of film, optical media, or any other media that may contain the motion picture. Once movie studio 12 creates hard disk 14, the movie studio ships the hard disk to data distributor 16.

Data distributor 16 receives hard disk 14 and creates master tape 18 to include a modified version (e.g., formatted) of the motion picture originally contained on hard disk 14. Data distributor 16 may modify the motion picture format, picture color, audio qualities, or any other changes that movie studio 12 may request. In addition, data distributor 16 modifies the motion picture data that will be stored on master tape 18 to include a desired digital file format, that organizes each block of data, encryption method for securing the stored data, and information that indicate the predetermined location of the user's data storage device that will store the motion picture, i.e., the plurality of data files. Data distributor 16 may also create markers on a header, footer, or both of master tape 18 that provide information to the user's tape system about the content, running length, file format, encryption method, or any other information that may be necessary or beneficial to include with the motion picture. Alternatively, a text file may be included with the plurality of data files that includes the information associated with the plurality of data files.

Many different types of encryption methods may be used to secure the plurality of data files within master tape 18 (and eventual data tapes 22). Data distributor 16 may simply change the file extensions of the plurality of data files or provide a unique identification code. Data distributor 16 may also add phantom data blocks within the plurality of data files to corrupt the plurality of data files to anyone who does not know which data blocks are the phantom blocks. Alternatively, data distributor 16 may randomize the location of a few blocks of data within the plurality of data files to prevent unwanted use of the plurality of data files. Other examples of an encryption method may include a separate encryption utility, modified file formats, or any combination of these methods to enhance the security of the motion picture in the plurality of data files.

Data distributor 16 may create master tape 18 to contain the plurality of data files specifically for targeted types of tape systems used by the end-users, i.e., the movie theaters 23A-23N. Further, data distributor 16 may even go to great lengths to prevent master tape 18, or any copies of the master tape, from being read by tape systems not used by the user. In this manner, data distributor 16 may prevent unwanted distribution of the motion picture. Once data distributor 16 finalizes master tape 18, the data distributor ships the master tape to data copier 20. In other examples, data distributor 16 may additionally perform the functions of data copier 20.

Data copier 20 is an entity that mass produces copies of master tape 18 for direct shipment to the user. In some cases, data copier 20 does not make any substantial changes to the plurality of data files contained on master tape 18. Data copier 20 mainly creates multiple copies of master tape 18 in the form of data tapes 22 for shipment to each intended user, e.g., movie theaters 23. However, data copier 20 may include a data tape specific code in each data tape 22 for the purposes of encrypting and/or identifying each data tape 22 separately and in a manner that is unique for each of movie theaters 23. For example, each of movie theaters 23 may require its own unique key to access the plurality of data files and play the motion picture each time the user requests the plurality of data files. This may prevent one of movie theaters 23 from using multiple data tapes 22 with the same key or allow movie studio 12 to control the use of the motion picture. Alternatively, each data tape 22 may be created specifically for an intended one of projectors 26. The plurality of data files may be configured for playback on a particular type of projector. In other examples, each data tape 22 may have a unique key that only allows the plurality of data files to be used by a particular one of projectors 26, e.g. projector 26A.

In addition, data copier 20 may attach an identification device to each data tape 22 to track each data tape and manage the use of each data tape. This identification device may be in the form of a radio frequency identification device (RFID) tag attached to each data tape 22 housing. The RFID tag may allow any entity in the distribution chain to track the location of each data tape 22. Moreover, the RFID tag may include information readable by the tape system of the particular movie theater 23 for which the respective data tape 22 has been created. For example, the tape system of movie theater 23A may be coupled to an RFID reader to produce an RF field and interrogate the RFID tag to acquire information about the file format, encryption method, motion picture content, plurality of data files size, predetermined location within the data storage device, type of projector necessary to play the motion picture, or any other information related to the motion picture stored in the particular data tape 22.

Once data copier 20 has created data tapes 22, the data copier ships each data tape to the respective one of movie theaters 23. As shown, data tape 22A is sent for use with data server 24A, data tape 22B is sent for use with data server 24B, and data tape 22N is sent for use with data server 24N. As will be described later in detail, each data tape 22 is inserted into a tape drive connected to the respective data server 24. A user associated with the movie theater provides a single input to transfer the plurality of data files to the predetermined location of a data storage device (not shown) connected to the respective data server 24. Once the plurality of data files is accessible by data server 24, the respective projector 26 (projector 26A, 26B, or 26N) may access the motion picture stored on the respective data storage device as the plurality of data files. In some examples, one or more of data servers 24 may be connected to multiple projectors within a theater at the user's location. In this case, it may be possible that any of these projectors can access the motion picture and play it for an audience.

Distribution system 10 exploits the advantages of data tapes 22 for the purpose of providing motion picture copies to theaters. Shipping data tapes 22 may reduce the cost associated with shipping other types of media such as film reels or hard disk drives. In addition, the single input from the user to transfer the plurality of data files of each data tape into the movie theater's tape system, e.g., the respective data server 24, simplifies the transfer of data from data tapes 22 such that a minimally skilled person can complete the process. Data tapes 22 may store a large amount of data, e.g., hundreds of gigabytes of data, in an inexpensive manner that is highly reliable with magnetic tape used for each data tape 22.

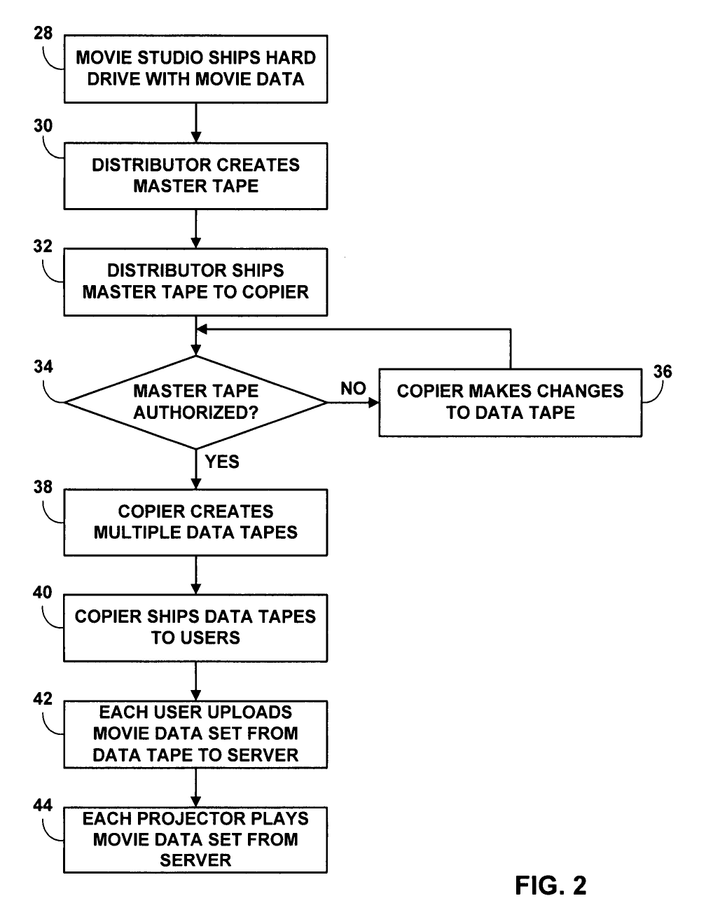

FIG. 2 is a flow chart illustrating the technique of FIG. 1 regarding distribution of a digital motion picture via magnetic tape media in distribution system 10. In other examples, another type of data other than a motion picture may be distributed according to the method of FIG. 2. As shown in FIG. 2, movie studio 12 creates hard disk drive 14 with the completed motion picture as movie data and ships the hard disk drive to data distributor 16 (28). Data distributor 16 then creates master tape 18 with the movie data constructed in a specific file structure, encryption method, and other changes necessary for playback as the plurality of data files (30). Data distributor 16 may also provide extra information within master tape 18 such as the predetermined location within a data storage device.

Data distributor 16 then ships master tape 18 to movie studio 12 to get authorization to duplicate the master tape (32). If master tape 18 is not authorized by movie studio 12 (34), data distributor 16 makes changes to master tape 18 until the content of the master tape is authorized (36). If master tape 18 is authorized by movie studio 12 (34), data distributor 16 ships master tape 18 to data copier 20 and the data copier create multiple data tapes 22 of the plurality of data files (38). Data copier 20 next ships data tapes 22 to each movie theater 23 specified by movie studio 12 (40). In some examples, data copier 20 may send a sample data tape 22 to data distributor 16 for authorization to distribute the content of data tapes 22.

Once one of movie theaters 23 receives one of data tapes 22 (such as data tape 22A), the user inserts data tape 22A into a respective tape drive and provides a single input to transfer, or upload, the plurality of data files from data tape 22 to data server 24A (42). The plurality of data files is directly stored within a data storage device connected to data server 24A. When the motion picture is desired to be played, the specific projector retrieves the plurality of data files from server 24A in order to display the motion picture to the audience (44). In some examples, the projector may retrieve the plurality of data files from a projector server networked to server 24A. The plurality of data files may be retrieved in its entirety before playing the motion picture or the plurality of data files may be streamed over the network such that it is only stored at a single data storage device.

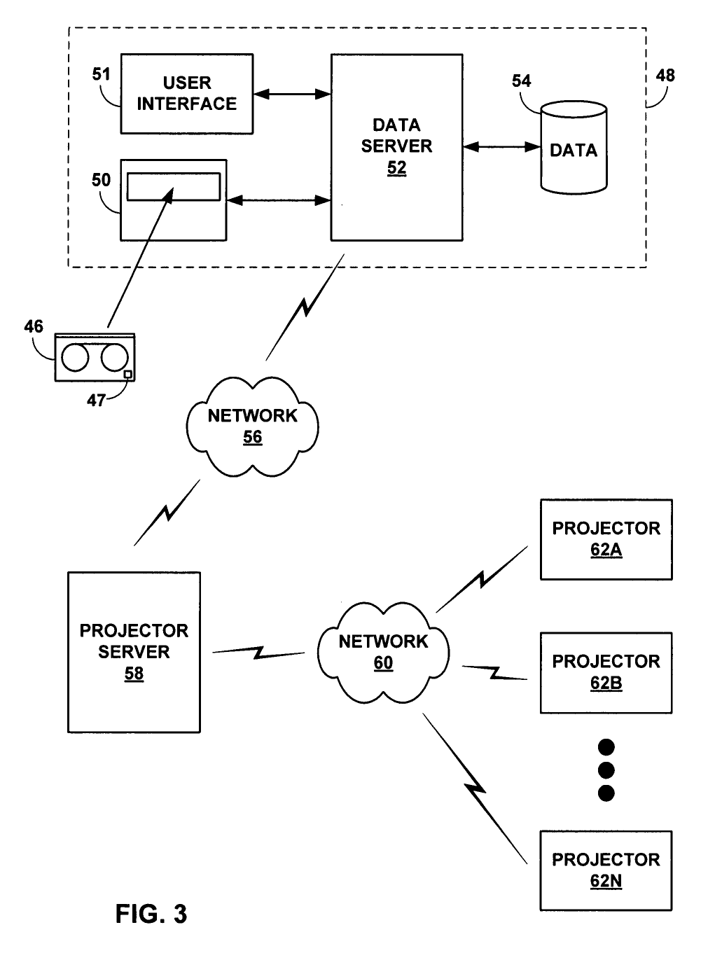

FIG. 3 is a block diagram of an example system that accepts a data tape, transfers the plurality of data files from the data tape to a data storage device, and provides the plurality of data files to networked projectors. As shown in FIG. 3, data tape 46 is used to provide the plurality of data files of the motion picture to tape system 48, where the tape system may be associated with any of movie theaters 23. Data tape 46 may be any of data tapes 22 of FIG. 1. The user may insert data tape 46 into tape drive 50. Tape drive 50 is in communication with data server 52 (where data server 52 is an embodiment of any of data servers 24 of FIG. 1). Data server 52 controls user interface 51, and the user interface receives input, e.g., a single input, from the user that controls the actions of data server 52 and the overall operation of tape system 48. Data server 52 is also in communication with data storage device 54 that contains one or more motion pictures until needed for playback in the theater.

Data tape 46 may be constructed as any type of magnetic tape capable of long-term storage of data. Preferably, data tape 46 is capable of storing the entire plurality of data files so that a user does not need to transfer the plurality of data files from multiple data tapes associated with only one motion picture. Data tape 46 may be in the form of an Advanced Intelligent Tape (AIT), a Digital Linear Tape (DLT), or a Linear Tape Open (LTO) format for magnetic tape media. Any generation of LTO tape may be used, such as LTO1, LTO2, LTO3, or others. Data tape 46 may be capable of storing at least 100 Gigabytes (GB), greater than 400 GB, or even greater than 800 GB. However, any capacity data tape 46 may be used as described herein.

Data tape 46 contains the plurality of data files that includes data representing the motion picture from movie studio 12 of FIG. 1. The plurality of data files of data tape 46 is defined by a marker located somewhere on the data tape, such as an initial portion of the media or on a header or footer. This marker may define the blocks of data tape 46 that contain the plurality of data files, the predetermined location within data storage device 54 at which the plurality of data files should be transferred to, or any other information related to the transfer of the plurality of data files or the use of the plurality of data files as the motion picture. This information may include file structure information and/or encryption method that secures the motion picture from unauthorized use.

The information may even instruct the creation of a folder at the predetermined location within data storage device 54 that is to contain the plurality of data files that represent the motion picture. In addition, the plurality of data files may be preserved once transferred to the predetermined location such that the motion picture remains intact for playback. Data tape 46 may instruct data server 52 to create a file structure within data storage device 54 that stores the plurality of data files in such a way that the digital motion picture is preserved and ready for transfer to a projector within the movie theater, e.g., any one of movie theaters 23.

All data stored in data tape 46, including the plurality of data files, is stored according to a file system defined by data distributor 16 with master tape 18. The file system used to arrange the plurality of data files, markers, or any other stored data may utilize many smaller data blocks that are written and read by a tape drive, e.g., tape drive 50. This file system may be specific to magnetic tape storage file systems commonly used in data storage tapes. Alternatively, the file system may be proprietary to data distributor 16 or data copier 20 in order to reduce unauthorized use of the plurality of data files for playback of the motion picture. Possible file systems may include NTFS, MXF, UNIX, Mac, Solaris, or any other proprietary or open source file system that movie studio 12 desires to be used for organizing the plurality of data files. The file system may also be modified to look like a standard file format but prevent the reading of the plurality of data files if a user tries to use the standard file format. In other examples, data tape 46 may not contain information about the file system used to store the plurality of data files on the data tape. Since data tape 46 is designed to be read by tape system 48, the tape system may automatically use a common file system to read the data from data tape 46.

In addition, encryption information may be included as data in data tape 46. The encryption information may be used to match a password or key stored in tape system 48. For example, data tape 46 may contain a unique product key that the user must provide to user interface 51 in order for the user to access the plurality of data files of the data tape. In some other examples, data tape 46 may contain multiple product keys that are only valid for a certain time period, number of uses, a particular theater, or a particular one of projectors 26. The user may need to purchase the matching product keys in order to continue using the plurality of data files, i.e., continue to display the motion picture. In alternate examples, the encryption method may utilize private and public keys to authenticate tape system 48 as authorized to play back the plurality of data files as the motion picture. Before the user is able to transfer the plurality of data files from data tape 46, or before each showing of the motion picture, the user may need to provide a matching public key to movie studio 12 that matches a private key corresponding to the plurality of data files of data tape 46.

In other examples, this information may be contained by a device on data tape 46 separate from the media. Data tape 46 may have an identification tag that is capable of providing information to tape system 48 without requiring reading data from the magnetic tape of data tape 46. In some examples, the identification tag may be a radio frequency identification (RFID) tag 47 attached to the housing of data tape 46. RFID tag 47 may be loaded with information by data duplicator 20 with information common to data tapes similar to data tape 46 and information unique to the specific data tape 46. Tape system 48 may include an RFID tag reader within tape drive 50 that energizes RFID tag 47 to read the information stored on the tag. The use of RFID tag 47 may facilitate the single input method of transferring the plurality of data files of data tape 46 by providing information normally manually entered by the user in conventional data transfer systems using data tapes.

RFID tag 47 of data tape 46 may be automatically interrogated by an RFID reader associated with tape system 48 or data server 52. Once the user inserts data tape 46 into tape drive 50, data server 52 triggers the function of the RFID reader to interrogate the RFID tag. After data server 52 receives the required information from RFID tag 47, the data server may prompt the user for the single input via user interface 51. In some examples, the RFID reader may be located near or within tape drive 50 to facilitate the interrogation of RFID tag 47. However, other examples may be able to provide the RFID reader at a larger distance away from RFID tag 47 of data tape 46. RFID tag 47 and RFID reader may be similar to any type of RFID devices commonly known in the art.

User interface 51 may include any type of device that is capable of receiving a single input from the user. However, user interface 51 may also be capable of accepting other types of user input related to or not related to the transfer of the plurality of data files from data tape 46. User interface 51 may be in the form of a graphical display and pointing device, similar to commonly known personal computing systems. In some examples, user interface 51 may include any of a touchscreen, a keyboard, one or more lights, one or more buttons, or any other type of device that allows the user to interact with tape system 48.

The user initiates the transfer of the plurality of data files from data tape 46 with a single input received by user interface 51. Once the transfer, or upload, is initiated, the plurality of data files is automatically read by tape drive 50 and transferred to data storage device 54 according to the information contained in data tape 46. The single input from the user is designed to shield the user from any complexity associated with recognizing the plurality of data files and transferring the data files to the correct location within data storage device 54. The plurality of data files may be transferred into a file created by data server 52 as instructed by the information of data tape 46. Tape drive 50 may be capable of fast read rates to speed up the transfer of the plurality of data files. For example, tape drive 50 may be capable of reading more than 10 Megabytes per second (MB/s). In other examples, tape drive 50 may be capable of reading more than 80 MB/s or even greater than 160 MB/s. These fast transfer rates may be beneficial over conventional media such as hard disk drives or optical media.

Data server 52 may be any type of computing system that includes a processor, memory, and other components necessary to manage the flow of data within tape system 48. Data server 52 is connected to data storage device 54 to store the plurality of data files and other data for an extended period of time. Data storage device 54 may be any type of long-term data storage medium. In other examples, data server 52 may be described as including data storage device 54. Typically, data storage device 54 includes one or more hard disk drives. The hard disk drives may be embodied as a RAID, SATA, IDE, or any other drive that allows for quick access to the information stored within data storage device 54. While magnetic tape media, optical media, and flash media may be used to store the plurality of data files of data tape 46, these data storage media may not be suitable for the long term storage and fast access necessary to data storage device 54 of tape system 48.

Tape system 48 is connected to projector server 58 via network 56. Specifically, data server 52 may transfer data between projector server as needed. Network 56 may be a local area network (LAN), internet, or other data communication technology. Projector server 58 provides each motion picture to a specific projector 62A, 62B or 62N (projectors 62) as needed for playing the motion picture to an audience. Projector server 58 is in communication with projectors 62 via network 60, e.g., a LAN or internet connection. Projector server 58 may communicate with any number of projectors 62. Each projector 62A, 62B and 62N may be located in a separate theater room to display the motion picture. In some embodiments, more than one of projectors 62 may be located in each theater room. Multiple projectors 62 may be necessary for displaying motion pictures in expanded views or three-dimensional formats, e.g., IMAX movies. Motion pictures are usually not stored with a specific one of projectors 62 in order to easily change which projector is capable of playing the motion picture by connecting to projector server 58 to play the motion picture.

Projector server 58 transfers the plurality of data files from tape system 48 over network 56 to the specific one of projectors 62 via network 60. Specifically, projector server 58 controls the manner in which the plurality of data files is delivered to each one of projectors 62 as needed for the playing of the motion picture. Projector server 58 may stream the motion picture data to each of projectors 62 such that the plurality of data files for the motion picture only needs to be stored at one location, e.g., data storage device 54. In other examples, projector server 58 may include another data storage device (not shown) that stores and presents the plurality of data files during times when the motion picture is playing on one of the projectors 62. In alternative examples, projectors 62 may be directly connected to data server 52 without projector server 58 and network 60.

The plurality of data files from data tape 46 includes all data necessary for complete playback of the motion picture to an audience. Sending the motion picture data to one of projectors 62 includes sending video data for playback by the projector and audio data for simultaneous playback through the audio system corresponding to that specific projector also via network 60. The delivery of the predetermined data to the specific one of projectors 62 may be initiated by the user through user interface 51 or through a user interface associated with the particular one of projectors 62. In some examples, delivery of the motion picture data from projector server 58 to one of projectors 62 may be initiated automatically by a preset timer set by the user.

In alternative examples of FIG. 3, multiple tape systems 48 may be located within a single theater complex. Each tape system 48 may be connected to one or more data storage devices 54 via a network. In addition, a single theater complex may include multiple projector servers 58 connected to a network with the multiple tape systems. Projectors 62 may include several projectors, where projector 62N may be in reference to any of the projectors. The theater complex may include between 1 and 20 projectors, and the theater complex may include more than 20 projectors.

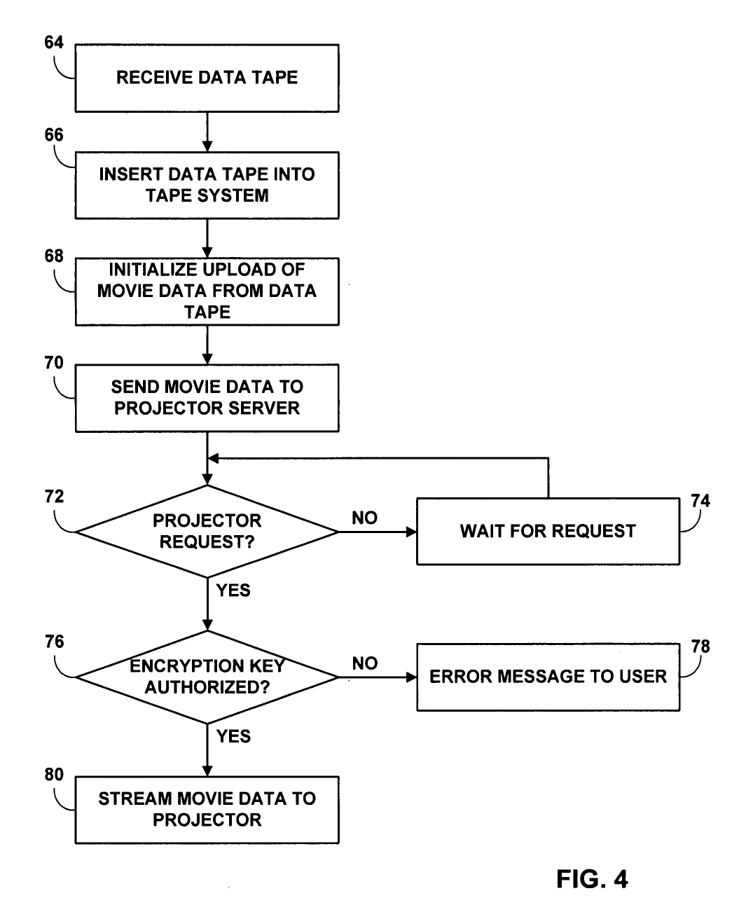

FIG. 4 is a flow chart illustrating an example technique of FIG. 3 regarding transfer and playback of the plurality of data files from a data tape. As shown in FIG. 4, the user receives data tape 46 from data copier 20 (64). The user inserts data tape 46 into tape system 48 when the user desires to transfer the plurality of data files from the data tape into the tape system (66). The user initializes the transfer of the plurality of data files from data tape 46 via a single input to tape system 48 (68). Tape system 48 then automatically completes the transfer of the plurality of data files to data storage device 54. This transfer is completed according to the information stored on data tape 46. For example, data tape 46 may instruct that data server 52 sends the plurality of data files to projector server 58 when the plurality of data files is to be used to present the motion picture (70).

If there is not a request to send the motion picture data to a projector (72), projector server 58 waits for a request (74). If projector server 58 receives a request for the motion picture data (72), projector server 58 checks if the encryption key is authorized to play back the motion picture (76). If the encryption key is not authorized, projector server 58 sends an error message to the user indicating the authorization failure (78). If the encryption key is authorized for motion picture playback by a projector (76), projector server 58 streams the motion picture data to the specified one of projectors 26 (80).

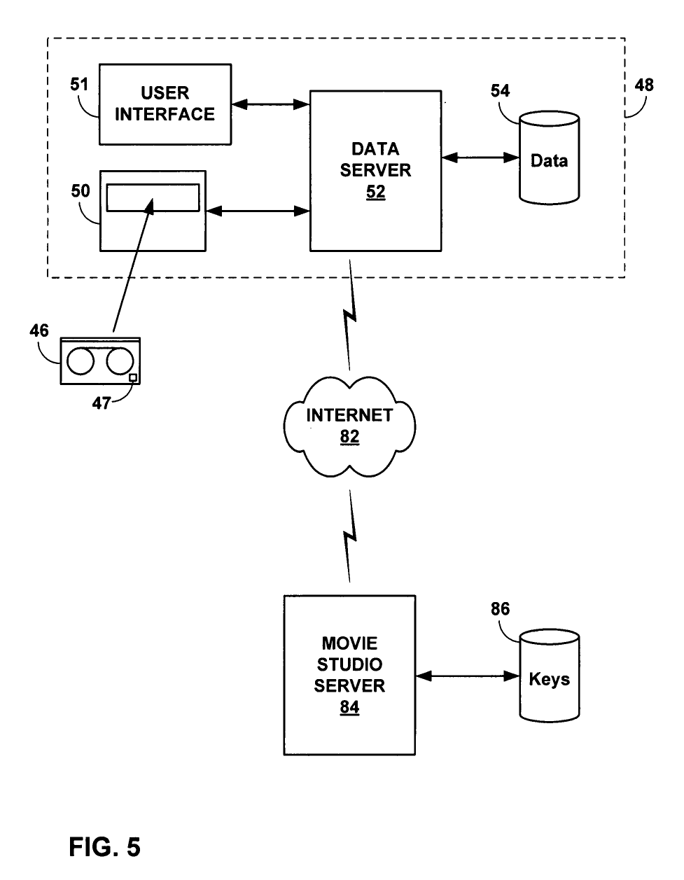

FIG. 5 is a block diagram of an example system that acquires encryption keys for playback of the plurality of data files. As shown in FIG. 5, data tape 46 is compatible with tape system 48, similar to FIG. 5. However, tape system 48 may also be connected to movie studio server 84 via internet 82. In this manner, the user may connect directly to movie studio server 84 to authenticate encryption keys and/or purchase new keys in order to play back the plurality of data files as the motion picture. Movie studio server 84 may be connected to key storage device 86 that stores the public keys used by the user to authenticate the playback of the motion picture.

Data server 52 may initially obtain a public key from movie studio server 84 after the plurality of data files is transferred from data tape 46 to data storage device 54. Data server provides identification information about tape system 48, e.g., theater identification, over internet 82 to movie studio server 84. Movie studio server 84 obtains the appropriate public key from key storage device 86 for the particular data tape 46. Data server 52 or projector server 58 may use the public key to authenticate the plurality of data files with the private key before the plurality of data files can be used to present the motion picture with one of projectors 26. In some embodiments, data server 52 may obtain the initial public key from the user or other source different from movie studio server 84.

In other examples, movie studio server 84 may allow the user or data server 52 to obtain new public keys when an old public key has expired due to the number of times the motion picture was presented or the playback period has elapsed. Data server 52 communicates with movie studio 84 and requests a new public key so that playback of the motion picture can continue. Data server 52 may purchase the new public key by depositing a preset amount of money into an account of movie studio 12. Movie studio server 84 then retrieves the appropriate public key from key storage device 86 and transfers the new public key over internet 82 to data server 52. In other examples, movie studio server 84 may generate a new public key upon request from data server 52 such that the new public key can be matched with a private key stored in key storage device 86 of movie studio server 84 before further playback of the motion picture.

In alterative examples, another type of encryption method may be utilized to authorize the playback of the plurality of data files as the motion picture. For example, simple product keys may be utilized that are matched to the specific plurality of data files of data tape 46. In addition, movie studio server 84 may incorporate security measures in which the plurality of data files is automatically destroyed if a certain set of criteria occurs. For example, the plurality of data files may be deleted from data storage device 54 if multiple unauthorized attempts to play back the motion picture occur. In addition, movie studio server 84 may cancel the account of data server 52 in some cases when a false public key is used to force the user to contact movie studio 12 to re-activate the plurality of data files or allow the user to again transfer the plurality of data files from data tape 46 back into tape system 48.

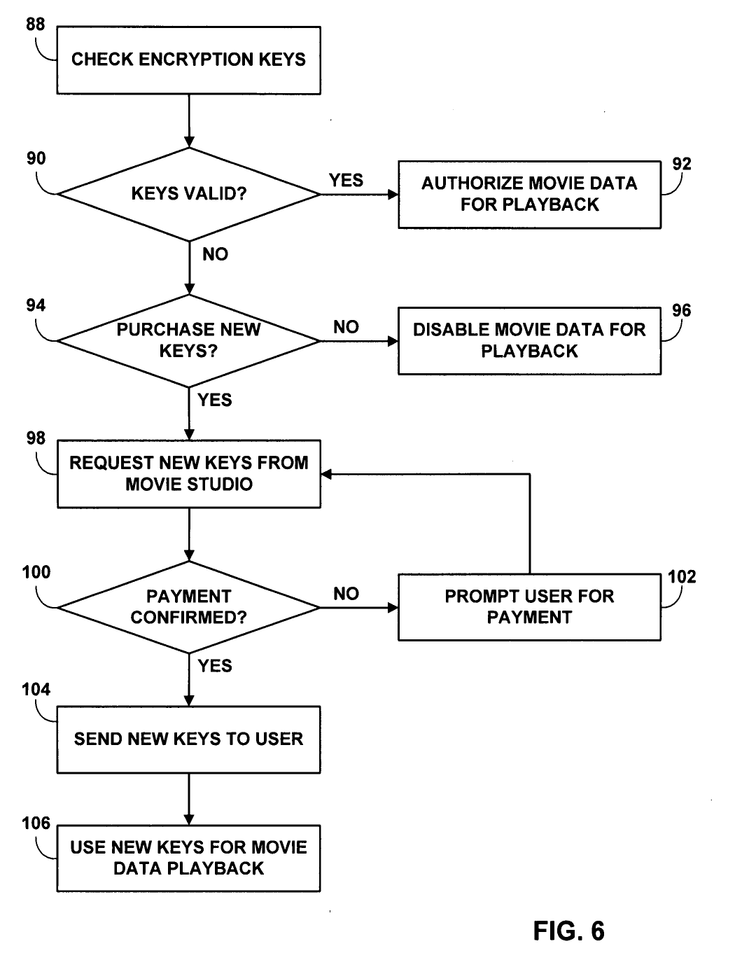

FIG. 6 is a flow chart illustrating the technique of FIG. 5 regarding acquiring encryption keys for the playback of the plurality of data files. The authorization method for motion picture playback using the plurality of data files begins with data server 52 checking the validity of the public key with the private key stored with movie studio server 84 (88). If the keys are valid (90), then movie studio server 84 validates the keys and authorizes the motion picture data for playback (92). If the keys are not valid (90), then movie studio server 84 requests if data server 52 desires to purchase new keys to enable motion picture playback (94). If the data server 52 does not attempt to purchase new keys, the plurality of data files is disabled and the motion picture cannot be presented (96).

If data server 52 desires to purchase new keys (94), data server 52 requests new keys from movie studio server 84 (98). If the payment for the new keys is not confirmed (100), movie studio server 84 prompts the user to provide payment for the new keys (102). If the payment for the new keys is confirmed (100), movie studio server 84 sends the new public key or keys to data server 52 or the user (104). Once the new public key is acquired, data server 52 may continue to send the plurality of data files to projectors 26 for motion picture playback (106).

FIG. 6 is only one example of a method for acquiring new encryption keys for authorization of continued use of the plurality of data files. In other examples, the user may be more involved with the purchase of new keys instead of automatic purchasing of new keys when needed. In addition, movie studio server 84 may allow a grace period for the use of an expired set of public and private keys to prevent customers from being unable to watch a motion picture. In this case, movie studio server 84 may keep track of each time the motion picture is presented to allow movie studio 12 to pursue further compensation. In addition, some users may prefer that movie studio 12 always keep track of the number of times a motion picture is presented and pay a bill for each of these times. This type of flexibility may be offered through the distribution system 10 described herein.

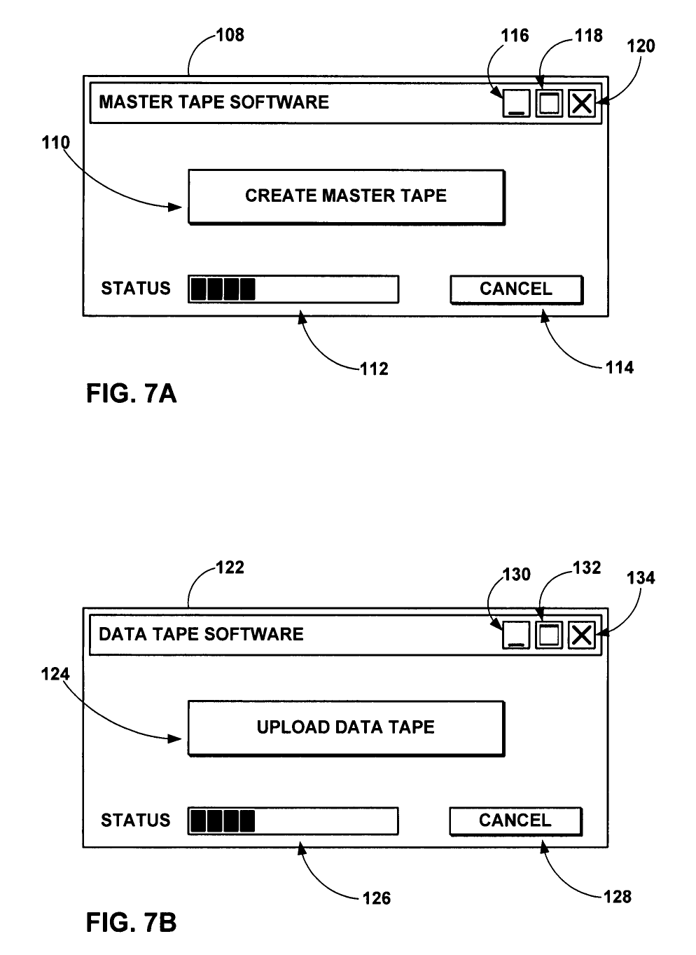

FIGS. 7A and 7B are example screen shots of writing the plurality of data files to the data tape and transferring the plurality of data files from the data tape, both with a single input from a user. As shown in FIG. 7A, graphical user interface (GUI) 108 includes create button 110, status bar 112, cancel button 114, minimize button 116, maximize button 118, and close button 120. GUI 108 is used on the computing system of the data distributor for creating the master tape 18 from hard disk 14, or another medium, sent by movie studio 12. GUI 108 may automatically appear to the user once a blank tape is inserted into the master tape drive and the system recognizes the blank tape. Alternatively, the user may open GUI 108 from a menu when the user desires to create the master tape 18. In some examples, the user may first upload the movie data contained in hard disk 14 to the data distributor system in order to format the movie data to the desired file system with the appropriate encryption methods. Other processing of the movie data may be completed before the movie data is ready for being written to the master tape 18 tape medium.

The user selects create button 110, a single input, to begin writing the movie data to the blank tape in the form of the plurality of data files. Writing the movie data to create master tape 18 may include writing information to a header and/or footer of the tape medium that includes the predetermined location of the plurality of data files in data storage device 54 (FIG. 3). In some examples, creating master tape 18 may also include writing information to the RFID tag, e.g., RFID tag 47, which may be a part of or attached to the blank tape. The information written to the RFID tag may include the master tape name, the file structure of the master tape, the plurality of data files, the predetermined location, content of the plurality of data files, a size of the plurality of data files, a tape history, a tape error, and an expiration time. The information may be written to the RFID tag of the black tape after the plurality of data files has been completely written to create master tape 18, e.g., any of data tapes 22 (FIG. 1). Writing information to the RFID tag after writing is completed may allow the RFID tag to include a complete history of master tape 18 creation.

During the writing process, the user may view the progress of creating master tape 18 via status bar 112. Status bar 112 fills as writing is completed. In other examples, status bar 112 may provide a numerical percentage of the progress in addition to or in place of the status bar. At any time, the user may select cancel button 114 to immediately stop writing the plurality of data files to the blank tape. Canceling the writing progress may render the written data on the tape useless. In some embodiments, the user may restart the creation progress from the point at which writing was stopped; such that the cancel button 114 performs an action similar to a pause action. The user may also control GUI 108 with minimize button 116 that makes GUI 108 disappear from view, maximize button 118 which makes GUI 108 the same size as the system screen, and close button 120 which shuts down GUI 108 and any associated processes.

In alternative examples, GUI 108 may contain more options for the user to adjust or customize the creation of master tape 18. For example, GUI 108 may contain fields for the file system type, encryption method, master tape name, predetermined location, plurality of data files, or any other user configurable options for master tape 18. Each field may have a preset default such that the user would only need to change a field if desired. GUI 108 may be controlled through a touchscreen, keyboard, pointing device, or any other input system for a user interface known in the art.

FIG. 7B, graphical user interface (GUI) 122 includes upload button 124, status bar 126, cancel button 128, minimize button 130, maximize button 132, and close button 134. GUI 122 is used on with user interface 51 of tape system 48 of the end user to transfer, or upload, the plurality of data files of data tape 46 into data storage device 54. Data tape 46 or any of data tapes 22 may be used with GUI 122. GUI 122 may automatically appear to the user via user interface 51 once data tape 46 is inserted into tape drive 50 and tape system 48 automatically recognizes data tape. Alternatively, the user may open GUI 122 from a menu when the user desires to transfer the plurality of data files.

The user selects create button 124, a single input, to begin transferring the plurality of data files from data tape 46 to data storage device 54. Tape system 48 identifies the predetermined location of data storage device 54 to store the plurality of data files. In addition, tape system acquires any other information provided by either information on the data tape or in an RFID tag that facilitates the transfer of the plurality of data files to data storage device 54. The entire transfer process is automated, so only the single input from the user is required. However, some examples may even automatically begin the transfer of the plurality of data files from data tape 46 when the user inserts data tape 46 into tape drive 50. In this case, the single input is the act of inserting data tape 46 into tape drive 50.

The user may view the progress of the transfer of the plurality of data files from data tape 46 via status bar 126. Status bar 126 fills as the transfer process moves toward completion. In other examples, status bar 126 may provide a numerical percentage of the progress in addition to or in place of the status bar. At any time, the user may select cancel button 128 to immediately stop the transfer of the plurality of data files to data storage device 54. Canceling the transfer progress may render the already transferred portion of the predetermined data in data storage device useless. In some examples, the user may restart the transfer process from the point at which the transfer was stopped; in this case cancel button 128 performs an action similar to a pause action. The user may also control GUI 122 with minimize button 130 that makes GUI 122 disappear from view, maximize button 132 which makes GUI 122 the same size as the system screen, and close button 134 which shuts down GUI 122 and any associated processes.

In alternative examples, GUI 122 may contain more options for the user to adjust or customize the transfer of the plurality of data files to tape system 48. For example, GUI 122 may contain input fields that allow the user to specify transfer rates, initial encryption keys, destination projectors 26, or any other option that the user may desire to select. GUI 122 may be controlled through a touchscreen, keyboard, pointing device, or any other input system of user interface 51 of tape system 48.

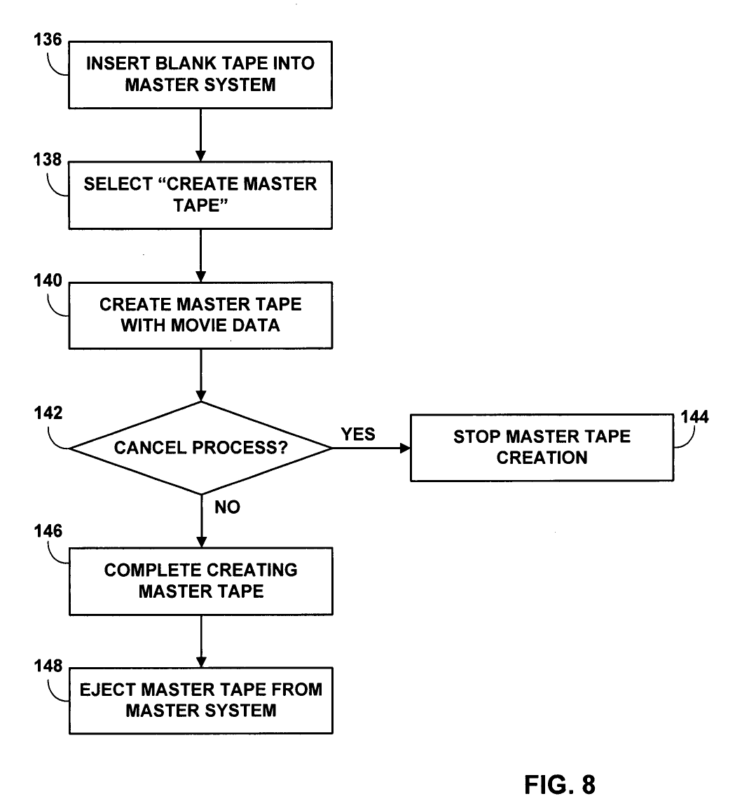

FIG. 8 is a flow chart illustrating the technique of FIG. 7A of writing a plurality of data files to a data tape with a single input from a user. As shown in FIG. 8, the user first inserts a black tape into the master system of data distributor 16 (136). The user then selects create master tape button 110 to initialize the creation of one of data tapes 22 (138). Data tape 46 may also be created. The master system then creates master tape 18 to include the motion picture as the plurality of data files and any other information necessary for the transfer and playback of the plurality of data files (140).

If the user selects cancel button 114 (142), then the master system stops the creation of master tape 18 and waits for further instructions from the user (144). If the user does not desire to cancel the creation process (142), the master system completes the creation of master tape 18 to include the entire plurality of data files of the motion picture (146). The master system then ejects master tape 18 from the master system (148). The user either then sends master tape 18 to movie studio 12 for authorization to send master tape 18 to data copier 20 or directly sends master tape 18 to data copier 20.

In other examples, the process of creating master tape 18 may be much more complicated and require a more knowledgeable technician to correctly create the master tape. For example, GUI 108 may include multiple other fields that need to be defined that allow for the easy transfer of the plurality of data files from data tapes 22 to the user and tape system 48. For example, GUI 108 may include multiple screens that prompt the user to enter correct information associated with the plurality of data files. These screens may include information related to the file structure of the plurality of data files, the encryption methods, and other specifications of the motion picture data. Once master tape 18 is verified as correct, the master tape may be sent to data copier 20 for duplication of data tapes which are shipped to the user for transfer and use in presenting the motion picture to audiences.

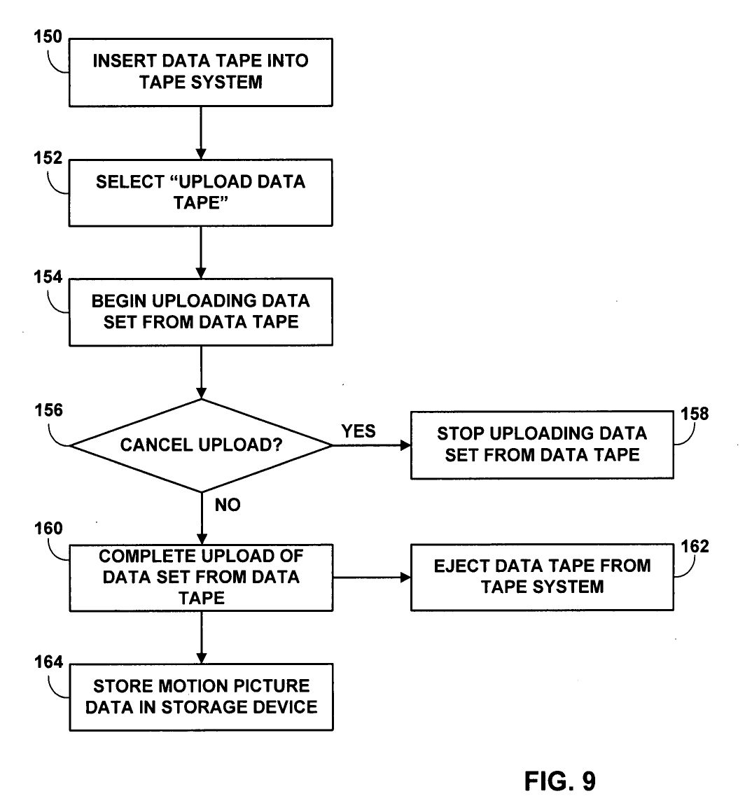

FIG. 9 is a flow chart illustrating the technique of FIG. 7B of transferring the plurality of data files from the data tape to a system with a single input from a user. As shown in FIG. 9, the user receives data tape 46 from data copier 20 and the user inserts the data tape into tape drive 50 of tape system 50 (150). While data tape 46 is described in this example, any of data tapes 22 may be used. User interface prompts the user to select upload button 124 to begin the transfer of the plurality of data files of data tape 46 (152). Once the user provides the single input to initialize the transfer process, data server 52 begins the transfer of the plurality of data files to data storage device 54 (154).

If the user selects cancel button 128 to cancel the transfer (156), tape system 48 stops the transfer of the plurality of data files to the predetermined location within data storage device 54 (158). If the user does not cancel the transfer (156), then tape system 48 completes the transfer of the plurality of data files from data tape 46 to data storage device 54 (160). Tape system 48 completes the storage of the plurality of data files in tape system 48 and may additionally store the plurality of data files in projector server 58 when appropriate (164). After the transfer of the plurality of data files is completed, data tape 46 is automatically ejected from tape drive 50 and tape system 48 (162).

In some examples, the user may be able to provide more input to tape system 48 before transferring the plurality of data files to data storage device 54. For example, the user may be able to select an advanced option that allows a more complex list of fields for the user to customize the transfer of the plurality of data files. In this manner, the user may be allowed more control of the process when desired but prevents advanced uses from needing to provide more information. If any error occurs during the transfer process, tape system 48 may attempt to correct the error and prompt the user for another single input to continue the transfer of the plurality of data files.

Many embodiments of the disclosure have been described. Various modifications may be made without departing from the scope of the claims. These and other embodiments are within the scope of the following claims.

1. A method comprising:
receiving, with a tape drive, a data tape that stores a digital motion picture arranged as a plurality of different data files, wherein the tape drive is coupled to at least one data server that stores a plurality of different digital motion pictures, wherein the data servers are coupled via a network to a plurality of digital movie projectors within a movie theater,
wherein in response to receiving the data tape within the tape drive, presenting a user interface to receive input from a user,
without requiring that the user provide more than a single input via the user interface, transferring the plurality of data files from the data tape to a predetermined location within the data server so that the digital motion picture is accessible to the digital motion picture projectors for presentation to an audience.

2. The method of claim 1, wherein transferring the plurality of data files comprises storing the plurality of data files to the predetermined location of the data storage device according to information contained in the data tape.

3. The method of claim 1, further comprising creating a folder in the predetermined location within the data storage device according to information contained in the data tape, wherein transferring the plurality of data files comprises placing the plurality of data files representing the motion picture into the folder in the predetermined location.

4. The method of claim 1, wherein the single input comprises selection of a button of a user interface.

5. The method of claim 1, further comprising:
transferring the plurality of data files from the data storage device to one of the projectors within the movie theater via the network; and
presenting the digital motion picture represented by the plurality of data files to the audience via the projector.

6. The method of claim 1, further comprising interrogating a radio frequency identification device (RFID) tag at least one of attached to or integrated into the data tape using an RFID reader coupled to the data server within the movie theater.

7. The method of claim 6, wherein interrogating the RFID tag comprises identifying an expiration time for which the movie theater is authorized to shown the additional digital motion picture.

8. The method of claim 6, wherein interrogating the RFID tag comprises identifying at least one of a data tape name, a file structure of the data tape, the plurality of data files, the predetermined location, content of the plurality of data files, a size of the plurality of data files, a tape history, or a tape error.

9. A system comprising:
a plurality of digital motion picture projectors within a movie theater, at least one data server to store a plurality of different digital motion pictures, wherein the data servers are coupled to the projectors via a network;
a data tape that stores an additional digital motion picture arranged as a plurality of different data files;
a tape drive coupled to the data server to receive the data tape; and
user interface software executing on the data server,
wherein in response to insertion of the data tape within the tape drive, the user interface software presents a user interface to receive input from a user, and
wherein the data server transfers the plurality of data files from the data tape to a predetermined location within the data server so that the additional digital motion picture is accessible by the digital motion picture projectors without requiring that the user provide more than a single input via the user interface.

10. The system of claim 9, wherein the-plurality of data files are transferred from the data storage device to one or more of the digital motion picture projector to present to an audience the additional motion picture represented by the plurality of data files.

11. The system of claim 9, wherein the data tape stores data that controls the transfer of the additional digital motion picture content from the data tape to the predetermined location within the data server so that the additional digital motion picture content is accessible by the digital motion picture projectors without requiring that the user provide more than a single input via the user interface.

12. The system of claim 9, further comprising:
a radio frequency identification device (RFID) tag attached to or integrated into the data tape; and
an RFID tag reader that interrogates the RFID tag to retrieve information to control the transfer of the additional digital motion picture from the data tape to the predetermined location within the data server so that the additional digital motion picture content is accessible by the digital motion picture projectors without requiring that the user provide more than a single input via the user interface.

13. The system of claim 12, wherein the RFID tag comprises a data tape name, a file structure of the data tape, the plurality of data files, data specifying the predetermined location and an expiration time for which the movie theater is authorized to shown the additional digital motion picture.
